(19) United States
(12) Patent Application Publication
(10) Pub. No.: US 2026/0103037 A1
(43) Pub. Date: Apr. 16, 2026

(54) HAND CRANK STRUCTURE OF TRAILER JACK

(71) Applicant: Lizhong Mo, Jiaxing (CN)

(72) Inventor: Lizhong Mo, Jiaxing (CN)

(21) Appl. No.: 19/421,320

(22) Filed: Dec. 16, 2025

(30) Foreign Application Priority Data
Dec. 8, 2025 (CN) 202522586109.4

(51) Int. Cl. B60D 1/66; B66F 13/00; G05G 1/08

(52) U.S. Cl. CPC B60D 1/66; B66F 13/00; G05G 1/085

(57) ABSTRACT

A hand crank structure of a trailer jack is provided, including a shaft, a rotating shaft, a handle assembly, a spring, and a locating ring. A circumferential locating hole is disposed on an end of the handle assembly, and the handle assembly is sleeved on the rotating shaft by using the circumferential locating hole and is able to move axially on the rotating shaft. A circumferential locating member is disposed in a moving range of the handle assembly corresponding to the rotating shaft, after the handle assembly slides outward, the circumferential locating hole cooperates with the circumferential locating member to rotate synchronously, and after the handle assembly slides inward, the circumferential locating hole is separated from the circumferential locating member.

### TECHNICAL FIELD

The present disclosure relates to the field of jacks, in particular to a hand crank structure of a trailer jack.

### BACKGROUND

Trailers on the existing market are generally hung on tails of vehicles by using towing structures, and are used to place luggage, goods, and the like. Generally, a jack is disposed at a head position of the trailer. The jack is configured to lift the head position of the trailer, so that the head position of the trailer is hung to the rear of the vehicle or disassembled from the tail of the vehicle.

In the prior art, a jack structure on a trailer generally includes a locating sleeve, a moving sleeve, and a transmission assembly. A lead screw is disposed in the locating sleeve. The moving sleeve is sleeved in the locating sleeve. A nut sleeve that cooperates with the lead screw is disposed inside the locating sleeve. There are two bevel gears and a rotating shaft in the transmission assembly. One bevel gear is fixed on the top of the lead screw. The rotating shaft is disposed on the top of the locating sleeve. The other bevel gear is fixed on the rotating shaft, and in addition, cooperates with the bevel gear on the lead screw. A handle is connected to an outer end of the rotating shaft. The rotating shaft rotates by rotating the handle, so as to drive the bevel gears and the lead screw to rotate and drive the moving sleeve to move up and down. At present, the handle is of a fixed structure, resulting in that a position of the handle cannot be fixed as required and some space may be occupied usually. In addition, there is a problem of accidental rotation caused by accidental contact.

### SUMMARY

Aiming at disadvantages in the prior art, the present disclosure provides a hand crank structure of a trailer jack, which solves a problem that a handle is easily rotated accidentally and cannot be located at a required position.

To achieve the above purpose, the present disclosure provides the following technical solution.

A hand crank structure of a trailer jack includes a rotating shaft, a handle assembly, a spring, and a locating ring, where
a circumferential locating hole is disposed on an end of the handle assembly, and the handle assembly is sleeved on the rotating shaft by using the circumferential locating hole and is able to move axially on the rotating shaft;
a circumferential locating member is disposed in a moving range of the handle assembly corresponding to the rotating shaft, after the handle assembly slides outward, the circumferential locating hole cooperates with the circumferential locating member to rotate synchronously, and after the handle assembly slides inward, the circumferential locating hole is separated from the circumferential locating member;
the spring is sleeved on the rotating shaft, and the handle assembly is jacked outward to the circumferential locating member; and
the locating ring is disposed on a locating sleeve of the jack, and is able to locate the handle assembly on the inside of the rotating shaft.

Preferably, the circumferential locating member is a hexagonal sleeve, and the circumferential locating hole is a hexagonal hole that cooperates with the hexagonal sleeve.

Preferably, a port of the circumferential locating hole is of a flared structure, and an inner end of the circumferential locating member is of a circular structure.

Preferably, a locating hole is disposed on the handle assembly, a locating bolt is disposed on the locating hole, and after the locating bolt is tightened, an end abuts against the circumferential locating member.

Preferably, the locating ring is of a C-shaped structure, two ends of the locating ring are connected to the locating sleeve of the jack, and after the locating ring rotates toward the handle assembly, the locating bolt is able to be locked, so that the handle assembly is kept on the inside of the rotating shaft.

Preferably, the handle assembly includes a connector, an extension rod, and a handle;
a pin is disposed on the connector, and the circumferential locating hole is disposed on the connector;
a slot that cooperates with the pin is disposed on an end of the extension rod; and
the handle is connected to an end that is of the extension rod and that is away from the connector.

The present disclosure has the following advantages.
1. When the handle assembly does not need to be used, the handle assembly is pressed inward, and then the handle assembly is locked by using the locating ring, so that the handle assembly is separated from the circumferential locating member, and the rotating shaft cannot be rotated accidentally. In addition, the handle assembly is effectively fixed by the locating ring, and cannot shake at random. When the handle assembly needs to be used, a pull ring is rotated so that the handle assembly moves outward to cooperate with the circumferential locating member, thereby having a characteristic of convenience in use.
2. When the handle assembly is not used, because the circumferential locating member is a hexagonal sleeve, the circumferential locating member may be used in cooperation with an electric structure, so as to rotate the rotating shaft electrically.
3. After the handle assembly is separated from the circumferential locating member, the handle assembly may rotate freely. Therefore, after the handle assembly is separated from the circumferential locating member at any angle, the handle assembly may rotate to a vertical state, and is locked by the locating ring in this state, thereby reducing space occupation.
4. A using state of the handle assembly may be switched only by moving inside and outside, and the handle assembly has the characteristics of simple structure and low space occupation.
5. When the handle assembly does not need to be located, the locating ring further may be used to carry a ring, so that the jack is convenient to take.

### BRIEF DESCRIPTION OF THE DRAWINGS

FIG. 1 is an explosive view of a handle crank structure of a trailer jack according to this embodiment;

FIG. 2 is a schematic diagram of a handle assembly when moving outward, that is, in a handle driving state according to this embodiment; and

FIG. 3 is a schematic diagram of a handle assembly when moving inward, that is, in an electric driving state according to this embodiment.

### DETAILED DESCRIPTION OF THE EMBODIMENTS

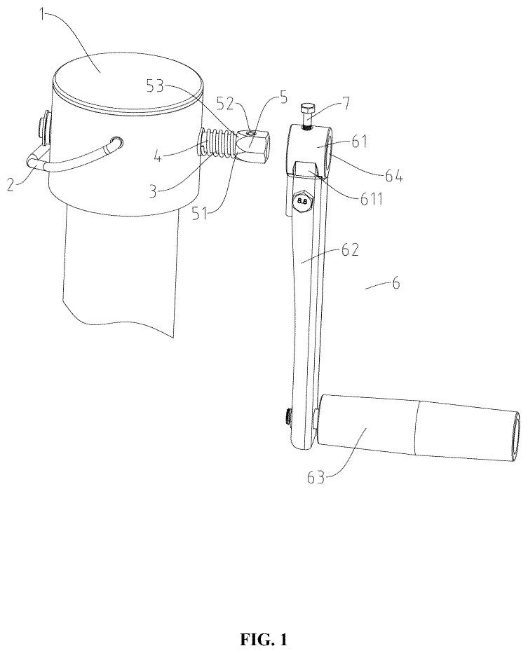

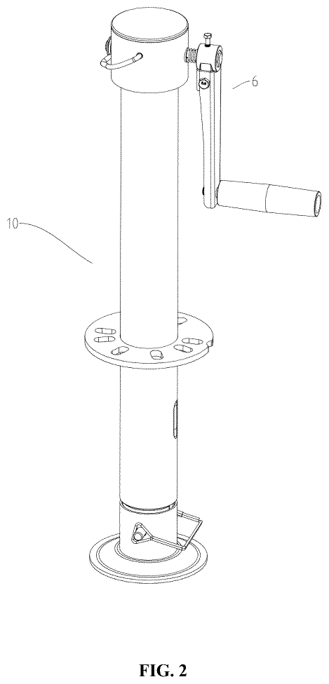

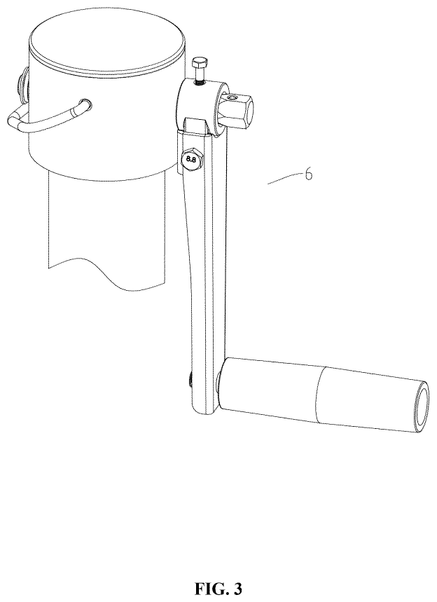

A hand crank structure of a trailer jack according to the present disclosure is further described in conjunction with the FIG. 1 to FIG. 3.

A hand crank structure of a trailer jack includes a rotating shaft 3, a handle assembly 6, a spring 4, and a locating ring 2.

The rotating shaft 3 is disposed in a horizontal state on a locating sleeve 1 of the jack. The rotating shaft 3 is connected to a bevel gear on a part on the inside of the locating sleeve 1, and cooperates with the bevel gear on a lead screw. The rotating shaft 3 is exposed to a part on the outside of the locating sleeve 1 for connection of the handle assembly 6. A circumferential locating hole 64 is disposed on an end of the handle assembly 6, and the handle assembly 6 is sleeved on a part that is of the rotating shaft 3 and that is located on the outside of the locating sleeve 1 by using the circumferential locating hole 64 and is able to move axially on the rotating shaft 3.

A circumferential locating member 5 is disposed in a moving range of the handle assembly 6 corresponding to the rotating shaft 3. The circumferential locating member 5 is located in an outermost position of the rotating shaft. When the handle assembly 6 slides outward, the circumferential locating hole 64 cooperates with the circumferential locating member 5 to rotate synchronously, and after the handle assembly 6 slides inward, the circumferential locating hole 64 is separated from the circumferential locating member 5 to rotate separately.

The spring 4 is sleeved on the rotating shaft 3. One end of the spring 4 abuts against the locating sleeve 1, and the other end of the spring 4 abuts against the handle assembly 6. The handle assembly 6 is jacked outward to the circumferential locating member 5. The locating ring 2 is disposed on the locating sleeve 1 of the jack, and is able to locate the handle assembly 6 on the inside of the rotating shaft 3, so that the circumferential locating member 64 is separated from the circumferential locating member 5.

The circumferential locating member 5 is a hexagonal sleeve, the hexagonal sleeve is sleeved in an end position of the rotating shaft 3 and then locked by using a locating bolt. The circumferential locating hole 64 is a hexagonal hole that cooperates with the hexagonal sleeve, so circumferential limiting between the circumferential locating hole 64 and the hexagonal sleeve may be realized. Then, a shape of the hexagonal sleeve is of a hexagonal structure, and may be used for a tool with an internally hexagonal hole to be inserted, so as to rotate the rotating shaft in cooperation with an electric structure.

A port of the circumferential locating hole 64 is of a flared structure, and an inner end of the circumferential locating member 5 is of a circular structure 53. When the handle assembly 6 moves from inward to outward, the flared structure and the circular structure may facilitate the circumferential locating hole 64 to be sleeved on the circumferential locating member 5.

A locating hole 52 is disposed in an end position of the handle assembly 6. A locating bolt 7 is disposed on the locating hole 52. After the locating bolt 7 is tightened, an end may abut against the circumferential locating member 5, so as to avoid a problem that the circumferential locating hole 64 is separated from the circumferential locating member 5 accidentally when the handle assembly 6 drives the rotating shaft 3 to rotate.

The locating ring 2 is of a C-shaped structure, two ends of the locating ring 2 are connected to the locating sleeve 1 of the jack 10, and after the locating ring 2 rotates toward the handle assembly 6, the locating ring 2 is able to hook the locating bolt 7 on thee handle assembly 6 moving inward, so that the handle assembly 6 is kept on the inside of the rotating shaft 3 and is separated from the circumferential locating member 5.

The handle assembly 6 includes a connector 61, an extension rod 62, and a handle 63.

The circumferential locating hole 64 is disposed on the connector 61, so that the connector 61 is fitted on the rotating shaft 3. A pin 611 extending radially outward is disposed on the connector 61. The pin 611 and the locating hole 52 are located on two sides opposite to the locating sleeve 1. A slot that cooperates with the pin is disposed on an end of the extension rod 62, and in addition, the slot and the extension rod 62 are locked by bolts. The handle is connected to an end that is of the extension rod 62 and that is away from the connector 61, so that the whole handle assembly 6 is convenient to rotate.

A using manner of the present disclosure is as follows. When the handle assembly 6 does not need to be used, the handle assembly 6 is pressed inward, and then the locating bolt 7 is tightened by using the locating ring 2, so that the handle assembly 6 is separated from the circumferential locating member 5, and the rotating shaft 3 cannot be rotated accidentally. In addition, the handle assembly 6 is effectively fixed by the locating ring 2, and cannot shake at random. When the handle assembly 6 needs to be used, a pull ring is rotated so that the handle assembly 6 moves outward to cooperate with the circumferential locating member 5, thereby having a characteristic of convenience in use.

Unless otherwise specified, in the present disclosure, it needs to be illustrated that the indicative direction or position relations of the terms such as “width”, “upper”, “lower”, “front”, “back”, “left”, “right”, “vertical”, “horizontal”, “top”, “bottom”, “inside”, “outside”, “clockwise”, “anticlockwise”, “axial”, “radial” and “circumferential” are direction or position relations illustrated based on the attached figures, just for facilitating the description of the present disclosure and simplifying the description, but not for indicating or hinting that the indicated device or element must be in a specific direction and is constructed and operated in the specific direction, and therefore, the terms for describing the position relations in the attached figures are used for illustrative description only, but cannot be understood as the restriction of the present disclosure. For ordinary skilled in the part, the specific meanings of the terms can be understood according to specific conditions in conjunction with accompanying drawings.

What is claimed is:

1. A hand crank structure of a trailer jack, comprising a rotating shaft, a handle assembly, a spring, and a locating ring, wherein
a circumferential locating hole is disposed on an end of the handle assembly, and the handle assembly is sleeved on the rotating shaft by using the circumferential locating hole and is able to move axially on the rotating shaft;
a circumferential locating member is disposed in a moving range of the handle assembly corresponding to the rotating shaft, after the handle assembly slides outward, the circumferential locating hole cooperates with the circumferential locating member to rotate synchronously, and after the handle assembly slides inward, the circumferential locating hole is separated from the circumferential locating member;
the spring is sleeved on the rotating shaft, and the handle assembly is jacked outward to the circumferential locating member; and
the locating ring is disposed on a locating sleeve of the jack, and is able to locate the handle assembly on the inside of the rotating shaft.

2. The hand crank structure of a trailer jack according to claim 1, wherein the circumferential locating member is a hexagonal sleeve, and the circumferential locating hole is a hexagonal hole that cooperates with the hexagonal sleeve.

3. The hand crank structure of a trailer jack according to claim 2, wherein a port of the circumferential locating hole is of a flared structure, and an inner end of the circumferential locating member is of a circular structure.

4. The hand crank structure of a trailer jack according to claim 1, wherein a locating hole is disposed on the handle assembly, a locating bolt is disposed on the locating hole, and after the locating bolt is tightened, an end abuts against the circumferential locating member.

5. The hand crank structure of a trailer jack according to claim 3, wherein the locating ring is of a C-shaped structure, two ends of the locating ring are connected to the locating sleeve of the jack, and after the locating ring rotates toward the handle assembly, the locating bolt is able to be locked, so that the handle assembly is kept on the inside of the rotating shaft.

6. The hand crank structure of a trailer jack according to claim 1, wherein the handle assembly comprises a connector, an extension rod, and a handle;
a pin is disposed on the connector, and the circumferential locating hole is disposed on the connector;
a slot that cooperates with the pin is disposed on an end of the extension rod; and
the handle is connected to an end that is of the extension rod and that is away from the connector.
